(19) United States
(12) Patent Application Publication
(10) Pub. No.: US 2023/0401255 A1
(43) Pub. Date: Dec. 14, 2023

(54) METHOD FOR GENERATING A PLAYLIST

(71) Applicant: SoundWaves LLC, Cambridge, MA (US)

(72) Inventor: Keith Cohen, Cambridge, MA (US)

(21) Appl. No.: 18/329,800

(22) Filed: Jun. 6, 2023

Related U.S. Application Data
(60) Provisional application No. 63/350,696, filed on Jun. 9, 2022.

(51) Int. Cl. G06F 16/638; G06F 16/683; G06F 16/955

(52) U.S. Cl. CPC G06F 16/639; G06F 16/683; G06F 16/955

(57) ABSTRACT

The present disclosure relates to a method for generating a music playlist. The method may be applied to a mobile device and include obtaining an audio file. The audio file may include at least one song. The mobile device may also obtain metadata of the audio file. The mobile device may further display information about the at least one song based on the metadata. The mobile device may, in addition, add the at least one song to a playlist based on the display information.

### CROSS-REFERENCE TO RELATED APPLICATION DATA

This application claims the benefit of and priority to Provisional U.S. Patent Application Ser. No. 63/350,696, filed Jun. 9, 2022, titled METHOD FOR GENERATING A PLAYLIST, the disclosure of which is incorporated herein by reference in its entirety.

### BACKGROUND

This disclosure is related to a method for generating a playlist.

Mobile, handheld devices, and other computing devices have allowed users to download and play digital files, including podcasts. A podcast is an audio or video program made available in digital format for download over the internet. The mobile or handheld device allows a user to listen to a podcast at their own convenience, including by fast-forwarding or rewinding through the podcast.

A podcast may include commentary on various topics as well as clips of music or other content. However, a user is limited to only listening to the podcast even though various content may be talked about or played within the podcast.

Accordingly, it is desirable to provide an improved method for interacting with content within an audio file.

### BRIEF SUMMARY

Examples of the present disclosure provide methods for generating a playlist.

According to a first aspect of the present disclosure, a computer-implemented method for generating a music playlist is provided. The method may be applied to a mobile device and include obtaining an audio file. The audio file may include at least one song. The mobile device may also obtain metadata of the audio file. The mobile device may further display information about the at least one song based on the metadata. The mobile device may, in addition, add the at least one song to a playlist based on the display information.

According to a second aspect of the present disclosure, a computer-implemented method for generating content links is provided. The method may be applied to a mobile device and include obtaining an audio file. The audio file may include at least one media content. The mobile device may also obtain metadata of the audio file. The metadata may include link information about the at least one media content. The mobile device may further display a window with a link of the at least one media content based on the metadata. The mobile device may, in addition, display link content based on the link of the at least one media content.

According to a third aspect of the present disclosure, a computing device is provided. The computing device may include one or more processors, a non-transitory computer-readable memory storing instructions executable by the one or more processors. The one or more processors may be configured to obtain an audio file. The audio file may include at least one song. The one or more processors may also be configured to obtain metadata of the audio file. The one or more processors may further be configured to display information about the at least one song based on the metadata. The one or more processors may in addition be configured to add the at least one song to a playlist based on the display information.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1A is an illustration of a user interface according to an embodiment.

FIG. 1B is another illustration of the user interface of FIG. 1A.

FIG. 1C is another illustration of the user interface of FIG. 1A.

FIG. 2A is an illustration of a user interface according to an embodiment.

FIG. 2B is another illustration of the user interface of FIG. 2A.

FIG. 2C is another illustration of the user interface of FIG. 2A.

FIG. 3A is an illustration of a user interface according to an embodiment.

FIG. 3B is another illustration of the user interface of FIG. 3A.

FIG. 3C is another illustration of the user interface of FIG. 3A.

FIG. 4A is an illustration of a user interface according to an embodiment.

FIG. 4B is another illustration of the user interface of FIG. 4A.

FIG. 4C is another illustration of the user interface of FIG. 4A.

FIG. 5 is a flow chart illustrating a method for generating a music playlist, according to an embodiment.

FIG. 6 is a flow chart illustrating another method for generating a music playlist, according to an embodiment.

FIG. 7 is a flow chart illustrating a method for generating a content link, according to an embodiment.

FIG. 8 is a flow chart illustrating another method for generating a content link is there, according to an embodiment.

FIG. 9 is a diagram illustrating a computing environment coupled with a user interface, according to an example of the present disclosure.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular. As used herein, the term “if” may be understood to mean “when” or “upon” or “in response to a judgment” depending on the context.

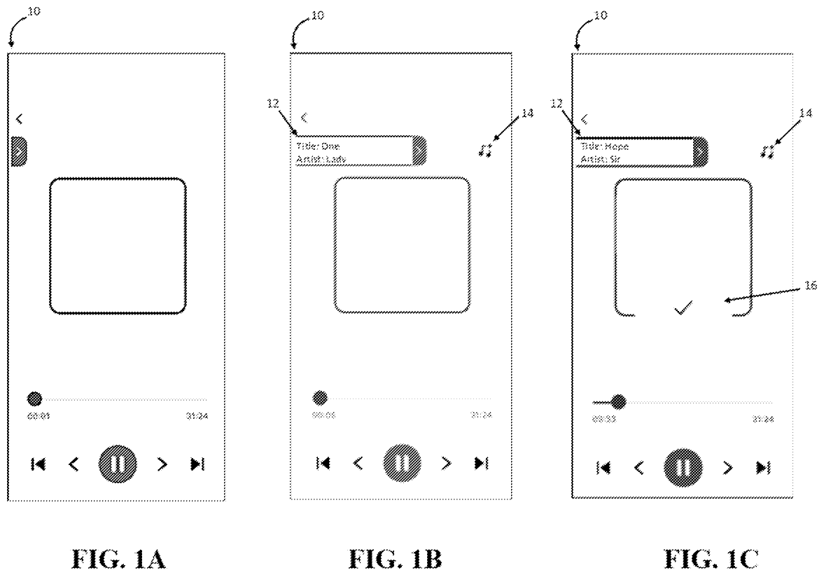

Referring now to the figures, FIGS. 1A-4C show a user interface 10 according to several embodiments. FIG. 1A shows the user interface 10 with a media player application playing a podcast or other music file. FIG. 1B shows the user interface 10 with a pop-up window 12 showing the title and artist name of a song being played in the podcast and a select icon 14 configured to add the currently playing song to a playlist. FIG. 1C shows the user interface 10 with the pop-up window 12 showing a title and artist name of a song currently being played in the podcast and a confirmation window (a checkmark 16) being displayed to show that the select icon 14 was selected and the song being played was added to the playlist. The playlist may be any list of video or audio files that can be played back on a media player.

In an embodiment, the podcast may be a live podcast that provides metadata of the media content mentioned or displayed in real time.

In another embodiment, the podcast may be dowloaded with its metadata and played offline.

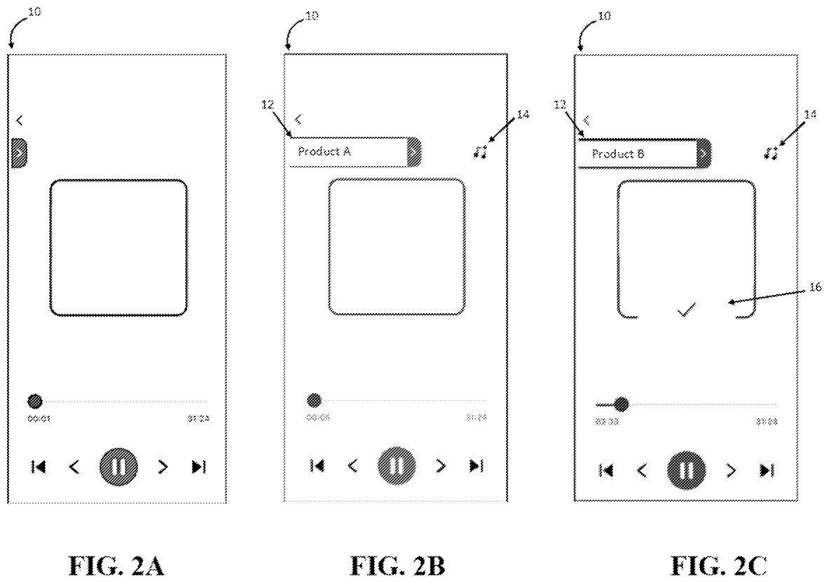

FIG. 2A shows a similar user interface 10 with a media player application playing a podcast or other music file. FIG. 2B shows the user interface 10 with a pop-up window 12 showing a product name (Product A is shown) being mentioned in the podcast and a select icon 14 configured to add a product to a shopping cart when selected. FIG. 2C shows the user interface with the pop-up window 12 showing a Product B currently being mentioned in the podcast and a confirmation window (a checkmark 16) being displayed to show that the select icon 14 was selected and the Product B being mentioned was added to the shopping cart.

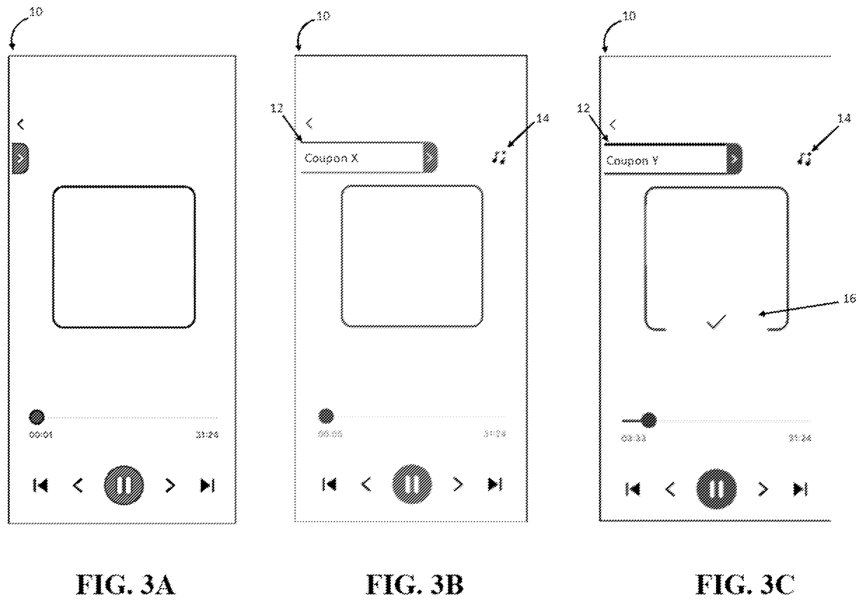

FIG. 3A shows a similar user interface 10 with a media player application playing a podcast or other music file. FIG. 3B shows the user interface 10 with a pop-up window 12 showing a coupon name (Coupon X is shown) being mentioned in the podcast and a select icon 14 configured to add a coupon to a user's account when selected. FIG. 3C shows the user interface with the pop-up window 12 showing a Coupon Y currently being mentioned in the podcast and a confirmation window (check mark 16) being displayed to show that the select icon 14 was selected and the Coupon Y being mentioned was added to the user's account.

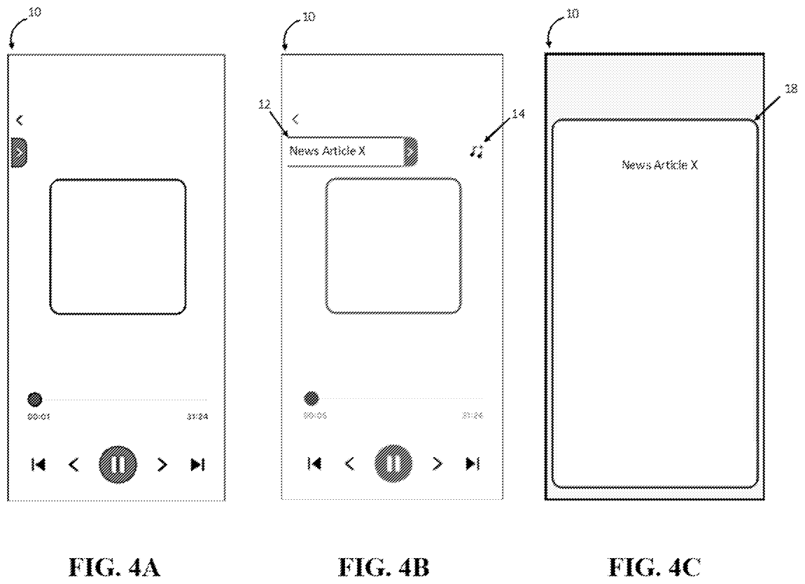

FIG. 4A shows a similar user interface 10 with a media player application playing a podcast or other music file. FIG. 4B shows the user interface 10 with a pop-up window 12 showing a name of a news article (News Article X is shown) being mentioned in the podcast and a select icon 14 configured to add a news article to a shopping cart when selected. FIG. 4C shows the user interface 10 with the pop-up window 18 displaying the News Article X. For example, the News Article X could be a news article regarding a review of an album. The pop-up window 12 would have the title of the article and pop-up window 18 would have the full article for a user to read once select icon 14 is selected.

In another embodiment, the News Article X may be opened in another application, for example, CHROME, SAFARI, another web-browser or application.

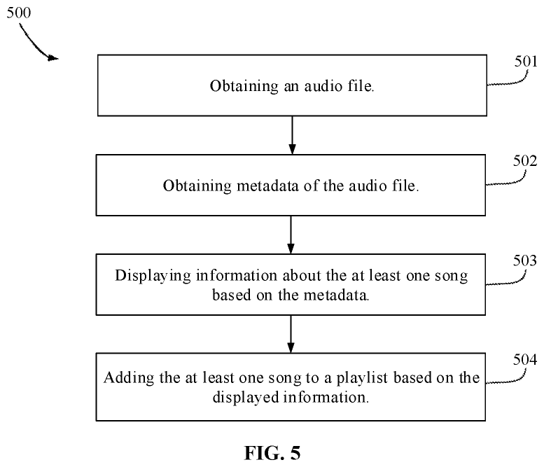

FIG. 5 shows a method 500 for generating a playlist in accordance with an embodiment. The method may be applied to a computing device such as a mobile device or handheld device.

In step 501, the computing device may obtain an audio file. For example, audio file may be an RAW, MP3, WAV, FLAC, or another type of audio file that may be uncompressed, formatted with lossless compression, or formatted with lossy compression. The audio file may include a podcast with one or more songs within the podcast. The audio file may be uploaded to a server and downloaded to an application on the mobile device. In addition, the audio file may be streamed to the computing device. The one or more songs may be only part of the songs and not the full song and the songs may be mixed or not.

In step 502, the computing device may obtain metadata of the audio file. For example, the audio file may have metadata for each song in the audio file. The metadata may either be entered manually by a user when uploading the audio file to a server, generated automatically by an application or algorithm, or downloaded from a server based on information, for example, the title of the song and artist name. For example, the application may extract each song from the audio file and acquire the metadata for each song from a library based on a comparison or recognition of the song.

In step 503, the computing device may display information about the at least one song based on the metadata. For example, the metadata may have information about the song and the start time and end time of the song in the audio file file. The start and end time of the song may also be used to navigate through the podcast to skip through songs. For example, each song or part of a song may be a chapter in the podcast and a user can skip chapters to skip individual songs. The information in the metadata may also include the artist name, the title of the song, the album the song appears on, the genre of the song, and links to the song from various online servers and websites. Other information of the song may be included in the metadata.

In an embodiment, each song of the audio file may be a chapter in the audio file where the chapter includes the start time and end time of the song based on the metadata. Additionally, the chapter information may be used to move through songs in the audio file. For example, a user may be listening to a podcast and may jump to the next or previous song by jumping to the next or previous chapter.

In an embodiment, the metadata of the audio file may be used to search for podcasts that mention a specific song or chapter in the podcast.

In step 504, the computing device may add the at least one song to a playlist based on the displayed information. For example, the computing device may add a song to a playlist on the application playing the podcast or audio file. The playlist may be a default playlist, the last playlist the user saved a song to, or a new playlist for the current user. The user may also have the ability to choose from multiple existing playlists.

In another embodiment, the computing device may display a tag icon that allows the user to tag the song being played so that the user can tag all the songs they want within a podcast and then add all those tagged songs to a playlist or send to another application. For example, the user may tag the first, fifth, and tenth song played in the podcast and then add the tagged songs (first, fifth, and tenth song) to a playlist at once. The tagging, for example, creates a list within the current media player based on the metadata of the audio file and when the user creates a playlist or wants to send the tagged songs to another application, the tagged song in the current media player is sent to the playlist or the other application.

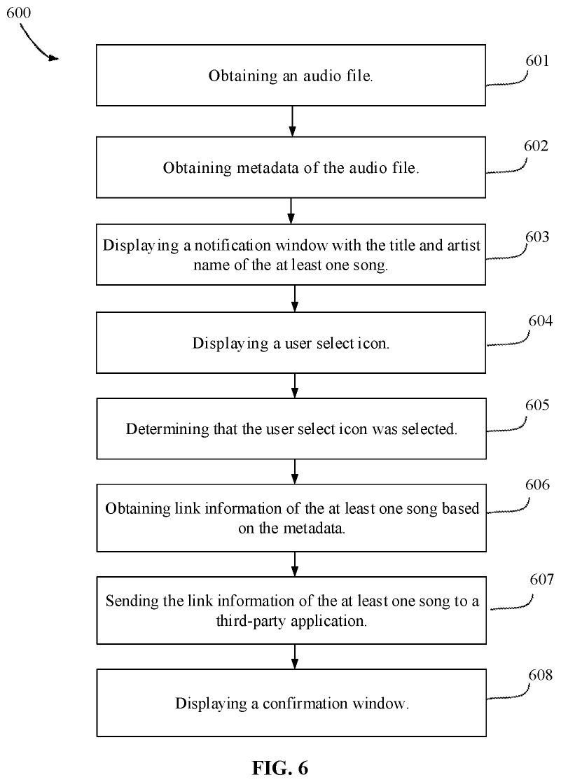

FIG. 6 shows a method 600 for generating a playlist in accordance to another embodiment. The method may be applied to a computing device such as a mobile device or handheld device.

In step 601, the computing device may obtain an audio file. The audio file may be similar to the audio file in step 501.

In step 602, the computing device may obtain metadata of the audio file. The metadata may be similar to the audio file in step 502.

In step 603, the computing device may display a notification window with a title and artist name of the at least one song. For example, the title of the song may be One and the artist's name may be Lady (as shown in pop-up window 12 in FIG. 1B). For example, the computing device may display the title and artist in a pop-up window when the song starts to play in the podcast (as shown in FIGS. 1B and 1C). The pop-up window, in another example, may display an image related to the song, including the singles album cover or the album cover with the title of the song.

In step 604, the computing device may display a user select icon. The user select icon, for example, may include a graphic symbol that a user can select to input an add or select command (as shown in FIGS. 1B and 1C by select icon 14).

In step 605, the computing device may determine that the user select icon was selected. For example, the computing device may determine that a user has selected the icon by simply pressing on the icon with, for example, a finger or stylus or by pressing and holding down on the icon.

In step 606, the computing device may obtain link information of the at least one song based on the metadata. For example, the computing device may obtain the uniform resource locator (URL) of the song selected. The URL may link to libraries such as APPLE MUSIC, SPOTIFY, YOUTUBE, video streaming platforms, other music streaming platforms or websites.

In step 607, the computing device may send the link information of the at least one song to a separate application. The computing device may be playing the audio file on a first application and the link information may be sent to a second application or third-party application. For example, the computing device may transmit a URL of the song from the media player application to a second application, for example SPOTIFY. The second application may then add the song to its playlist based on the URL. The second application selected to receive the link information may be set by a user beforehand or it may be a default application so that the song selected is added to the library without having to switch between applications. In another example, the computing device may send the link information to all media player applications.

In step 608, the computing device may display a confirmation window. For example, the computing device may display a window that is configured to communicate to the user that the selected song has been added to the playlist.

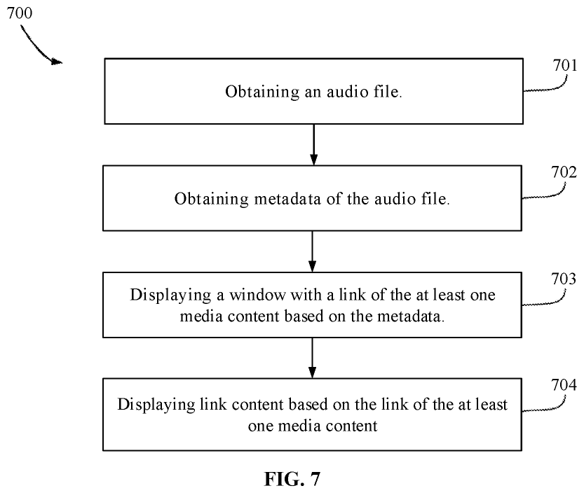

FIG. 7 shows a method 700 for generating content links in accordance with an embodiment. The method may be applied to a computing device such as a mobile device or handheld device.

In step 701, the computing device may obtain an audio file. The audio file may be similar to the audio file in step 501.

In step 702, the computing device may be metadata of the audio file. The metadata may be similar to the audio file in step 502.

In step 703, the computing device may display a window with a link of the at least one media content based on the metadata. For example, the name of a product may be displayed (as shown in pop-up window 12 in FIG. 2B). The computing device may display a product name Product A in a pop-up window when the product is mentioned in the podcast (as shown in FIGS. 2B and 2C). The pop-up window, in another example, may display an image related to the product.

In an embodiment, the media content may be any content that may be displayed on a display screen based on a link or metadata. For example, an article, a news article, a publication, a website, an image, an email or new email, a commercial, a product description, a separate application, a crypto wallet, a downloaded file, a new calendar event, phone settings, a social media post, a new message, a reminder, a new booking, an APP store, a new reservation, a new food delivery order, a maps applications, or a coupon. The media content displayed may also have pre-populated information. For example, a new reservation for a flight may already have the dates, destination and any discounts that are applicable based on the metadata. In another example, a new email may have information regarding the recipient, body of the email, and subject.

In step 704, the computing device may display link content based on the link of the at least one media content. The user select icon may be similar to the user select icon in step 604 and as shown in FIG. 2C.

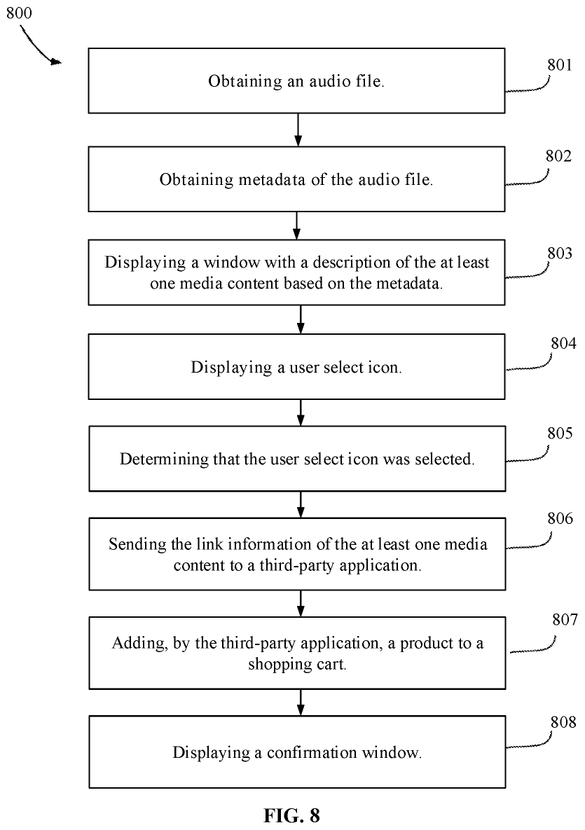

FIG. 8 shows a method 800 for generating a playlist in accordance with another embodiment. The method may be applied to a computing device such as a mobile device or handheld device.

In step 801, the computing device may obtain an audio file. The audio file may include at least one media content. The audio file may also be similar to the audio file in step 501.

In step 802, the computing device may obtain metadata of the audio file. The metadata may be similar to the audio file in step 502.

In step 803, the computing device may display a window with a description of the at least one media content based on the metadata. The metadata may include link information about the at least one media content. The window displayed may be similar to step 703.

In step 804, the computing device may display a user select icon. The user select icon may be similar to the user select icon in step 604 and as shown in FIG. 2C.

In step 805, the computing device may determine that the user select icon was selected. The computing device may determine that the user select icon was selected similarly as in step 605.

In step 806, the computing device may send the link information of the at least one media content to a separate application. The computing device may be playing the audio file on a first application and the link information may be sent to a second application or third-party application. For example, the computing device may transmit a URL of the product from the media player application to a separate application, for example, AMAZON.

In another example, the media content may be a coupon mentioned in a podcast. The computing device may transmit the coupon information to a separate application to be saved onto a user's account for later checkout.

In step 807, the computing device may add, by the separate application, a product to a shopping cart. For example, the separate application may add the product to a shopping cart based on the URL. The separate application selected to receive the link information may be set by a user beforehand or it may be a default application so that the product selected is added to the shopping cart without having to switch between applications.

In step 808, the computing device may display a confirmation window. For example, the computing device may display a window that is configured to communicate to the user that the product has been added to the shopping cart.

In an embodiment, while listening to an audio file, a user can either add a song currently being played in the auto-created playlist of a media player application through integrated application programming interface (API) and can also “Like” a song to add in their personal library on a media player application, such as SPOTIFY and APPLE MUSIC.

In an embodiment, the computing device may determine if the user is a new user and require the user to login to the media player application in which the playlist will be generated.

In an embodiment, a separate application, for example, CHROME, SAFARI, AMAZON, or another web-browser or application may open to show the product in the shopping cart.

In another embodiment, the metadata of the podcast may be streamed live with the podcast or it may be dowloaded with the full podcast and may allow advertisers to show targeted advertisements (ads) to a user based on the media content being mentioned on the podcast. The ad may be displayed on the pop-up window or on a separate pop-up window that may be different from other pop-ups (pop-up showing the current songs information) based on the color of the pop-up. For example, the pop-up with the ad may be yellow while the pop-up showing the current songs information is white.

In one or more embodiments, the audio file may be a video file that may be processed as described in FIGS. 5-8.

In another embodiment, the audio file may be a live stream video on a social media application that live streams metadata of the media content in the live stream. For example, a user may be live streaming a talk about of a specific song or product and metadata may be generated and streamed with the live stream so that an application may display pop-ups related to the media content. The application may be, for example, INSTAGRAM, FACEBOOK, OR TIK TOK.

The present disclosure improves mobile technology by providing an improved method for generating a playlist or content links from an audio file. Currently, in order to create a playlist from an audio file like a podcast, a user must determine the song they hear in a podcast, obtain the information for the song, including title and artist name, and find the song within a media player platform so that they can add it to a playlist. This becomes even more complicated if the podcast is playing on one application and the user has to switch to a second application to add it to a playlist in that application. Similarly, in order to interact with content being discussed in an audio file, a user must determine the content name (for example, a product's name, articles name, coupon's information) and obtain further information about the content to be able to find it in a separate application (for example, a web browser, a shopping application, or within a user's account in another application). The present disclosure improves the mobile technology by determining, obtaining, sending, and generating playlists or links based on content in an audio file and therefore improves a user's experience and dramatically reduces the steps involved to add a favorite song to a playlist.

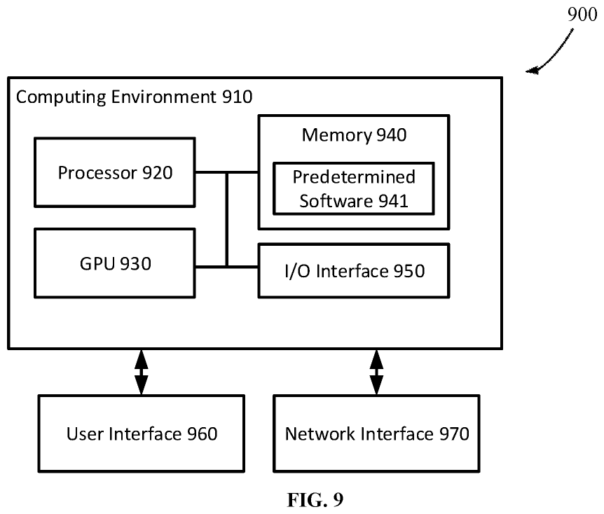

FIG. 9 shows a computing system 900 with a computing environment 910 coupled with a user interface 960 and network interface 970 according to an embodiment. The computing environment 910 may be part of a data processing server, mobile terminal or handheld device. The computing environment 910 includes processor 920, graphical processing units 930, memory 940, and I/O interface 950.

The processor 920 typically controls overall operations of the computing environment 910, such as the operations associated with the display, data acquisition, data communications, and image processing. The processor 920 may include one or more processors to execute instructions to perform all or some of the steps in the above-described methods. Moreover, the processor 920 may include one or more modules that facilitate the interaction between the processor 920 and other components. The processor may be a Central Processing Unit (CPU), a microprocessor, a single chip machine, or the like.

The memory 940 is configured to store various types of data to support the operation of the computing environment 910. Memory 940 may include predetermined software 941. Examples of such data comprise instructions for any applications or methods operated on the computing environment 910, video datasets, image data, etc. The memory 940 may be implemented by using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 950 provides an interface between the processor 920 and peripheral interface modules, such as a keyboard, a click wheel, buttons, a touch screen, and the like. The buttons may include but are not limited to, a home button, a start scan button, and a stop scan button. The I/O interface 950 can be coupled with an encoder and decoder.

Network Interface 970 provides communication between the processing unit and an external device. The communication can be done through, for example, WIFI or BLUETOOTH hardware and protocols. The Network Interface 970 may communicate with a mobile network that connects to the internet and webservers.

User interface 960 may be a mobile terminal or a display.

In some embodiments, there is also provided a non-transitory computer-readable storage medium comprising a plurality of programs, such as comprised in the memory 940, executable by the processor 920 in the computing environment 910, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 910 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

It is understood that this terminology is non-limiting in nature. In addition, it is understood that one or more various features of an embodiment above may be used in, combined with, or replace other features of a different embodiment described herein.

All patents referred to herein, are hereby incorporated herein in their entirety, by reference, whether or not specifically indicated as such within the text of this disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A method for generating a playlist comprising:
obtaining an audio file, wherein the audio file comprises at least one song;
obtaining metadata of the audio file;
displaying information about the at least one song based on the metadata; and
adding the at least one song to a playlist based on the displayed information.

2. The method of claim 1, wherein the metadata of the audio file comprises a start time and an end time of the least one song within the audio file.

3. The method of claim 2, wherein the metadata of the audio file comprises a title and artist, information of the at least one song.

4. The method of claim 1, wherein adding the at least one song to the playlist based on the displayed information comprises:
obtaining link information of the at least one song based on the metadata; and
adding the at least one song to the playlist based on the link information.

5. The method of claim 4, wherein the link information comprises a uniform resource locator (URL) of the at least one song.

6. The method of claim 1, wherein adding the at least one song to the playlist based on the displayed information comprises:
obtaining link information of the at least one song based on the metadata; and
sending the link information of the at least one song to a separate application, wherein the separate application comprises a playlist and is configured to add the at least one song to the playlist.

7. The method of claim 1, wherein displaying the information about the at least one song based on the metadata comprises:
displaying a notification window with a title and artist name of the at least one song; and
displaying a user select icon, wherein the user select icon, when selected, inputs an add to library command.

8. The method of claim 7, wherein adding the at least one song to the playlist based on the displayed information comprises:
determining that the user select icon was selected;
obtaining link information of the at least one song based on the metadata; and
adding the at least one song based on the link information.

9. The method of claim 7, wherein adding the at least one song to the playlist based on the displayed information comprises:
determining that the user select icon was selected;
obtaining link information of the at least one song based on the metadata;
sending the link information of the at least one song to a separate application, wherein the separate application comprises a playlist and is configured to add the at least one song to the playlist; and
displaying a confirmation window, wherein the confirmation window is configured to show that the at least one song was added to the library.

10. The method of claim 1, further comprising:
obtaining at least one chapter for the audio file based on the metadata, wherein the at least one chapter is a time stamp of where a song begins and ends in the audio file; and
skipping to the at least one chapter in the audio file.

11. A method for generating content links comprising:
obtaining an audio file, wherein the audio file comprises at least one media content;
obtaining metadata of the audio file, wherein the metadata comprises link information about the at least one media content;
displaying a window with a link of the at least one media content based on the metadata; and
displaying link content based on the link of the at least one media content.

12. The method of claim 11, wherein the at least one media content comprises an article, a news article, a publication, a website, a product, or a coupon.

13. The method of claim 11, wherein the metadata comprises a start time and end time of the at least one media content within the audio file.

14. The method of claim 13, further comprising:
obtaining a uniform resource locator (URL) of the at least one media content.

15. The method of claim 11, wherein displaying the window with the link of the at least one media content based on the metadata comprises:
displaying the window with a description of the at least one media content based on the metadata; and
displaying a user select icon, wherein the user select icon, when selected, inputs a select command.

16. The method of claim 15, further comprising:
determining that the user select icon was selected;
sending the link information of the at least one media content to a separate application; and
displaying a confirmation window, wherein the confirmation window shows that the at least one media content was sent to the separate application.

17. The method of claim 16, further comprising:
processing, by the separate application, the link information of the at least one media content.

18. The method of claim 17, wherein processing the link information of the at least one media content comprises:
adding, by the separate application, a product to a shopping cart, wherein the link information comprises the product, and wherein the separate application comprises the shopping cart.

19. The method of claim 17, wherein processing the link information of the at least one media content comprises:
adding, by the separate application, a coupon to a user's account, wherein the link information comprises the coupon, and wherein the separate application comprises the user's account.

20. A computing device comprising:
one or more processors; and
a non-transitory computer-readable storage medium storing instructions executable by the one or more processors, wherein the one or more processors are configured to:
obtain an audio file, wherein the audio file comprises at least one song;
obtain metadata of the audio file;
display information about the at least one song based on the metadata; and
add the at least one song to a playlist based on the displayed information.
